(19) United States
(12) Patent Application Publication
(10) Pub. No.: US 2008/0129638 A1
(43) Pub. Date: Jun. 5, 2008

(54) Composite Structure for an Antenna and a Shell

(76) Inventor: Ching-Long ONG, Taichung County (TW)

Correspondence Address: Dr. BANGER SHIA, 102 Lindencrest Ct., Sugar Land, TX, 77479-5201, US

(21) Appl. No.: 11/874,193

(22) Filed: Oct. 17, 2007

(30) Foreign Application Priority Data
Nov. 30, 2006 (TW) 095221173

(51) Int. Cl. H01Q 1/40

(52) U.S. Cl. 343/873

(57) ABSTRACT

A composite structure for an antenna and a shell, wherein the antenna mode is pre-set on the surface of the shell of the computer or the electric appliances before the shell is formed. The main layers are preimpregnated with resin and then are subjected to integral forming process, so that the antenna is laminated on shell to improve the stability of the whole structure. Further, on the shell surface can be disposed a plurality of antenna modes. And since the shell is a main layer which naturally can acts as a conductive shield to improve the function and efficiency of the antenna mode.

### BACKGROUND OF THE INVENTION

1. Field of the Invention

The present invention relates to a composite structure for an antenna and a shell, and more particularly a structure used on the electric products with antenna, wherein the antenna mode is laminated on the main layers of the shell, so as to achieve the purpose of high stability and hidden effect.

2. Description of the Prior Art

Currently, an assembling structure for an antenna mode and the shell of a computer or other electric appliances usually includes a mounting hole or notch defined in the shell of mounting the antenna mode, or as disclosed in TW application serial No. 0578942, the printed circuit board (PCB) type antenna is provided with a fixing structure for connecting to the computer shell, and the antenna is fixed by screws. Such a structure is inconvenient to assemble. Furthermore, the antenna can be touched or disassembled from outside, so when an impact or an external force is encountered, the antenna is likely to fall off.

Further, TW application serial No. 0578942 discloses a metal shield with an antenna connecting structure, which comprises a hollow metal housing defined by folding an upper piece and a side piece. A metal plate extends horizontally or vertically a predetermined length from an appropriate portion of the lower edge of the top end of the upper piece, so as to form an antenna at the top end of the upper piece. One side of the top end of the upper piece extends along the end of the antenna to form a signal input terminal for the antenna of the metal shield. And then both sides of the side piece extend outward to form a plurality of extensions which can form earthing terminal after the metal shield is formed. The antenna is combined inside the metal shield, and such a structure also requires an extra antenna mounting structure, so its assembly is relatively complicated and stability is poor. Further, such a shell structure also needs to be assembled to the electric appliances, which causes inconvenience in use.

The present invention has arisen to mitigate and/or obviate the afore-described disadvantages.

### SUMMARY OF THE INVENTION

The primary objective of the present invention is to provide a composite structure for an antenna and a shell. The antenna mode is pre-set in the mode before the shell is formed. The main layers are preimpregnated with resin and then are subjected to integral forming process, so that the antenna is laminated on shell to improve the stability of the whole structure. Further, on the shell surface can be disposed a plurality of antenna modes. And since the shell is a main layer which naturally can acts as a conductive shield to improve the function and efficiency of the antenna mode.

### BRIEF DESCRIPTION OF THE DRAWINGS

FIG. 1 is a perspective view showing a composite structure of an antenna and a shell in accordance with the present invention before it is formed;

FIG. 2 is a perspective view showing a composite structure of an antenna and a shell in accordance with the present invention after it is formed;

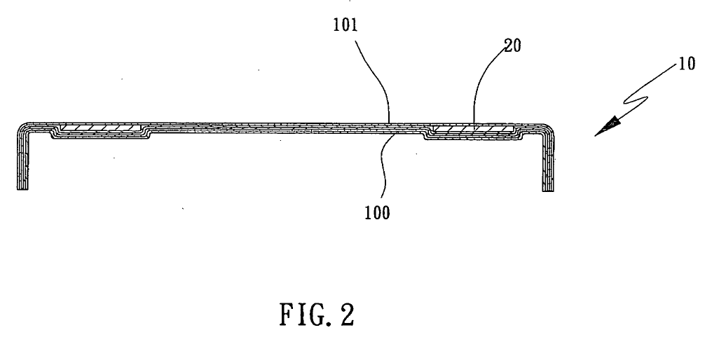

FIG. 3 is a illustrative view showing that the antenna and the shell being put into the mold; and

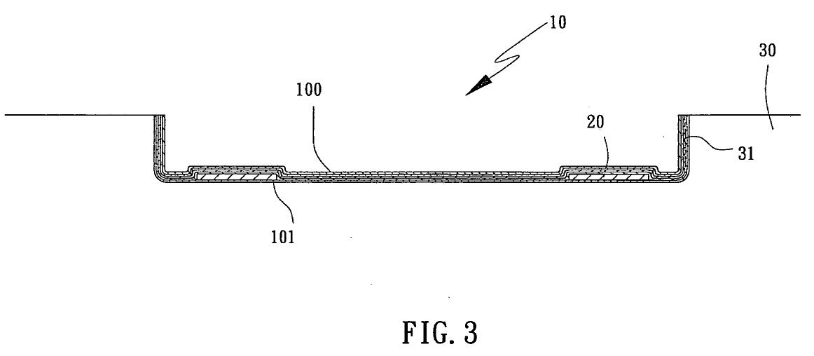

FIG. 4 is a flow chart of forming the composite structure of an antenna and a shell in accordance with the present invention.

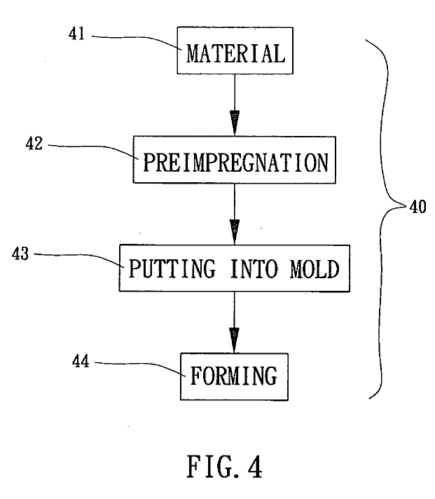

### DETAILED DESCRIPTION OF THE PREFERRED EMBODIMENT

The present invention will be clearer from the following description when viewed together with the accompanying drawings, which show, for purpose of illustrations only, the preferred embodiment in accordance with the present invention.

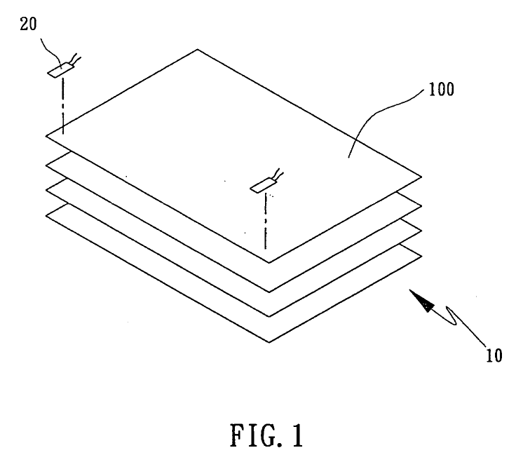

Referring to FIG. 1, the present invention comprises at least more than one antenna mode 20 before a shell 10 is formed. The antenna mode 20 can be a general antenna structure for wireless communication or can be a bluetooth antenna mode.

The shell 10 is integrally formed by putting a plurality of resin-preimpregnated main layers 100 into a cavity 31 of a mold 30 and heating them under pressure.

The main characteristic of the present invention is that the antenna mode 20 is placed at an appropriate position before the main layers 100 are putted into the cavity 31 of the mold 30. And then the resin-preimpregnated main layers 100 are putted into the cavity 31 of the mold 30 and are heated under pressure. After the shell 10 is formed, the antenna mode 20 will be laminated on the surface of the shell 10 automatically.

A method 40 of making the composite structure comprises the steps of:

Choosing material 41: preparing a plurality of a properly cut or uncut carbon fiber made main layers 100, the layers 100 are superposed to each other.

Preimpregnating 42: preimpregnating the superposed main layers 100 with resin;

Putting into the mold 43: putting the antenna 20 into the cavity 31 of the mold 30, and then laminating with the resin preimpregnated main layers 100; and

Forming 44: forming an integrally formed shell 10 with at least more than one antenna mode 20 on the outer surface thereof by heating under pressure.

With the appropriately resin preimpregnated main layers 100, the outer surface of composite structure of the shell 10 and the antenna 20 will form a transparent or resin-colored layer 101 to protect the shell 10 and the antenna 20 after the shell 10 is formed, so as to achieve the purpose of high stability and integrity.

Further, the resin of the main layers 100 can be glued to the antenna mode 20, naturally producing an isolation effect. The main layers 100 can be made of fiber, and the fiber can be conductive or nonconductive. The conductive fiber can be carbon fiber or metal conductive fiber, while the nonconductive fiber can be fiberglass or other nonmetallic fiber. If the main layers 100 are made of carbon fiber, the carbon fiber itself is conductive, which naturally produces a conductive shielding effect, so as to prevent the electromagnetic wave generated by the antenna mode 20 from affecting imaging process of the screen, and can form a shied between users, thus providing an high safety and integral antenna structure. If the main layers 100 are made of fiberglass, the nonconductive main layers 100 are laminated with conductive material, so that the nonconductive main layers 100 have a conductive function and can produce a conductive shielding effect.

While we have shown and described various embodiments in accordance with the present invention, it is clear to those skilled in the art that further embodiments may be made without departing from the scope of the present invention.

What is claimed is:

1. A composite structure for an antenna and a shell, comprising:
a shell with a plurality of main layers;
at least more than one antenna mode being placed on a surface of the main layers before forming the shell, and then the antenna mode being automatically integrally formed with the shell after the shell is formed.

2. The composite structure for an antenna and a shell as claimed in claim 1, wherein the shell formed by a plurality of resin-preimpregnated main layers.

3. The composite structure for an antenna and a shell as claimed in claim 1, wherein the antenna mode is of one of the following types: an antenna structure for wireless communication, and a bluetooth antenna mode.

4. The composite structure for an antenna and a shell as claimed in claim 1, wherein the main layers are preimpregnated with a predetermined amount of resin, a outer surface of composite structure of the shell and the antenna will be formed with a transparent layer or a layer of a color corresponding to a color of the resin after the shell is formed.

5. The composite structure for an antenna and a shell as claimed in claim 1, wherein the main layers are made of fiber.

6. The composite structure for an antenna and a shell as claimed in claim 1, wherein the main layers are made of conductive or nonconductive fiber.
